(19) United States
(12) Patent Application Publication
(10) Pub. No.: US 2019/0307112 A1
(43) Pub. Date: Oct. 10, 2019

(54) COLLAPSIBLE FISHING CHAIR

(71) Applicant: Charles Alfred LIPSEY, Middle River, MD (US)

(72) Inventor: Charles Alfred LIPSEY, Middle River, MD (US)

(21) Appl. No.: 16/374,459

(22) Filed: Apr. 3, 2019

Related U.S. Application Data
(63) Continuation of application No. 62/652,560, filed on Apr. 4, 2018.

(51) Int. Cl. A01K 97/22; A01K 97/10; G01B 3/04

(52) U.S. Cl. CPC A01K 97/22; G01B 3/04; A01K 97/10

(57) ABSTRACT

A collapsible fishing chair has a frame structure including multiple beams and multiple panels, the multiple beams being configured to form a chair frame and the multiple panels being configured to form supporting surfaces that extend between beams, the supporting surfaces including a seating surface and a backrest surface. A measuring device for measuring length is provided on at least one armrest for use in measuring the length of a fish; and at least one fishing rod receptacle is joined to at least beam of the chair frame for receiving and retaining a handle-end of fishing rod.

### FIELD OF THE INVENTION

The present invention relates to a collapsible chair, and particularly a collapsible fishing chair having a support for holding a fishing rod.

### BACKGROUND OF THE INVENTION

A conventional collapsible chair, sometimes referred to as a lawn chair, generally includes a frame structure composed of multiple beams that form a chair frame and multiple panels that form support surfaces, typically including a seat panel, a back panel, and in some instances a leg panel.

The frame structure of a conventional collapsible chair is configured to readily transition between folded and unfolded states thereby providing the convenience of a seating device that is compactable to a reduced size for transportation and storage.

The convenience offered by collapsible chairs has been long appreciated, as the ability to collapse and expand such chairs makes them ideal, for example, on camping trips, beach trips, parade watching, and stargazing. Another particular use of conventional collapsible chairs is seating during recreational fishing trips, in which a the collapsible chair may be transported to a desired fishing location.

On occasions when a user may employ a collapsible chair on a fishing trip there may be instances in which the user may cast a fishing line and let it remain afloat rather than reeling the line in. For example, a fisherman may cast a line and permit the line to rest in one place while waiting for a fish to bite. In another example, a fisherman may cast a line from a moving boat and permit the line to drag behind the boat. In such instances, it would be helpful if there were a way to leave the fishing rod in a fixed position so that the fisherman may be free to do other things while waiting for a fish to bite at the line.

### SUMMARY OF THE INVENTION

The present invention is inclusive of a collapsible fishing chair having multiple beams that form a chair frame and multiple panels that form support surfaces that extend between beams, the support surfaces may include a seating surface, and a backrest surface, and a leg rest surface.

The chair further includes armrests, which may be formed by either a number of beams, a number of panels, or a combination of beams and panels. The armrests have retention structures for receiving and retaining accessories, such as a drink container, a modern cell phone, and a paperback novel. At least one of the armrests also includes a measuring device for measuring length, such as a scale ruler for measuring the length of a fish, the ruler extending along a length of the armrest either in the form of a printed scale or engraved scale.

The chair further includes a fishing rod receptacle, which in on example may take the form of a cylindrical tube having an open-end and a length dimensioned to receive and retain a handle-end of fishing rod in a fixed position. In another example the fishing rod receptacle may take the form of a clamp mechanism that is operable between an open state for insertion and removal of a fishing rod, and a close state for retention of a fishing rod. The receptacle may be mounted in a fixed position at an angle, relative to the ground, that is between 30° and 90°, preferably between 45° and 75°, and more preferably between 55° and 70°. In another example, the receptacle may be rotatably mounted to the chair frame so as to be selectively positionable at any desired angle in a fully 360° range.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows a collapsible fishing chair according to the present invention; and

FIG. 2 shows a close-up of an armrest of the fishing chair in FIG. 1.

### DETAILED DESCRIPTION OF THE INVENTION

The following disclosure discusses the present invention with reference to the examples shown in the accompanying drawings, though does not limit the invention to those examples.

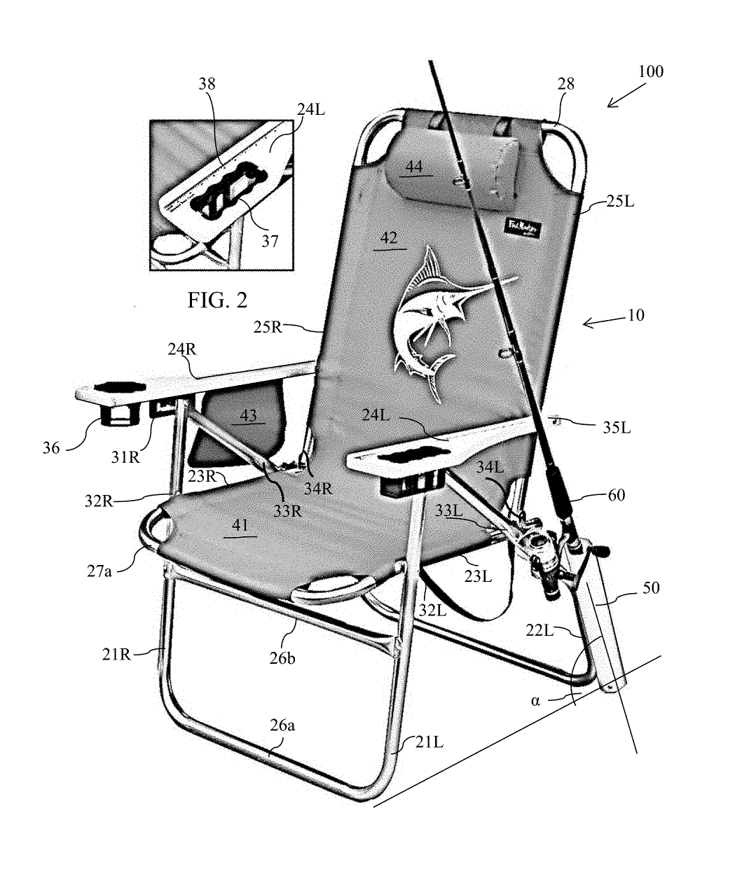

The present invention is directed to a collapsible chair 100 composed of multiple beams and multiple panels, the multiple beams being configured to form a chair frame 10 and the multiple panels being supported between beams to form multiple support surfaces. In the example shown in FIG. 1, a collapsible chair 100 according to the present invention includes beams in the form of two front legs 21R/L, two rear legs 22R/L, two seat beams 23R/L, two armrests 24R/L and two seat-back beams 25R/L. The chair 100 further includes a lower lateral leg beam 26a and an upper lateral leg beam 26b that both extend between the two front leg beams 21R/L; a front lateral seat beam 27a and a rear lateral seat beam 27b that both extend between the two seat beams 23R/L; and a lateral seat-back beam 28 that extends between the two seat-back beams 25R/L.

The chair frame 10 includes a number of pivot joints for facilitating transition of the chair 100 between a collapsed state and an expanded state. In the example shown in FIG. 1, there is provided pivot joints 31R/L that join the front legs 21R/L, rear legs 22R/L and armrests 24R/L; pivot joints 32R/L that join front legs 21R/L and seat beams 23R/L; pivot joints 33R/L that join rear legs 22R/L and seat beams 23R/L; pivot joints 34R/L that join seat beams 23R/L and seat-back beams 25R/L; and pivot joints 35R/L that join armrests 24R/L and seat-back beams 25R/L. The pivot joints are configured to enable the collapsible chair 100 to readily collapse to a compact form for transportation and storage, and to again expand to a state for sitting.

In the example shown in FIG. 1, the beams forming armrests 24R/L are made of wood, whereas the remaining beams of the chair frame are each made of metal. The armrests 24R/L each have a hole formed in the top surfaces thereof, with a retention structure 36/37 inserted in each respective hole. The hole and retention structure 36 in right armrest 24R are shaped to receive and retain a cylindrical object (e.g., a conventional beverage container), whereas the hole and retention structure 37 in left armrest 24L are shaped to receive and retain a rectangular object (e.g., a book or modern cellular phone). In the example shown in FIG. 1, the left armrest 24L includes a measuring device 38 for measuring length—specifically, in this example, the length-measuring device is a scale ruler 38 that extends along a length of the armrest 24L. As shown in FIG. 2, the scale ruler 38 is printed along the surface of the armrest 24L, though in other examples the scale ruler 38 may be engraved along the surface of the armrest 38. The scale ruler provides a convenient measuring device for measuring the length of fish.

The chair 100 includes a first panel 41 that extends laterally between the two seat beams 23R/L to form a support surface in the form of a seat rest, and a second panel 42 that extends laterally between the two seat-back beams 25R/L to form a support surface in the form of a back-rest. In this example, the first panel 41 and the second panel 42 are in fact two portions of a single continuous sheet of fabric that extends to also connect with the front lateral seat beam 27a and the lateral seat-back beam 28 so as to provide a single continuous support surface. The chair 100 further includes a third panel 43 in the form of an accessory pouch 43 suspended from the right armrest 24R; and a fourth panel 44 shaped and filled with a supportive material so as to form a head rest cushion 44.

The chair 100 further includes a fishing rod receptacle 50 joined to a rear leg, the receptacle 50 being configured to receive and retain a handle-end of a fishing rod 60. In the example shown in FIG. 1, the receptacle 50 is joined to the left rear leg 22L and is formed as a cylindrical tube that extends along the rear leg 22L with an opening at a top-oriented end thereof. The receptacle 50 may be oriented at any chosen angle α, provide the orientation is sufficient to retain the fishing rod 60 within the receptacle. For example, if preferring to orient the fishing rod 60 in a position to enable continued floating of a fishing line, then the receptacle 50 may be oriented at an angle α of 30° to 90°; preferably between 45° and 75°; and more preferable between 55° and 70°—the angle α of orientation being measured relative to a flat ground level on which the chair 100 rests.

Though the example in FIG. 1 shows the receptacle 50 joined to left rear leg 22L, a chair 100 according to the present invention may instead have the receptacle 50 joined to any chosen portion of the chair frame 10. For example, the receptacle 50 may be connected to either rear leg 22R/L or either front leg 21R/L; may be connected to either armrest 24R/L; or may be connected to either seat-back beam 25R/L.

Though the example in FIG. 1 shows the receptacle 50 in the form of a cylindrical tube that extends along a beam of the chair frame 10, a chair 100 according to the present invention may include a receptacle formed in any other configuration that is adequate for receiving and retaining a fishing rod 60 in a fixed position. For example, the receptacle may instead be formed as a clamping mechanism that is operable between an open state for insertion and removal of the fishing rod 60, and a closed state for retaining the fishing rod 60 in a fixed. Also, the receptacle may be joined to the chair frame 10 by a pivoting mechanism such that the angle α of the receptacle may be freely adjusted as desired, preferably with the receptacle being adjustable by a full 360°. Such a pivoting mechanism may be provided in the form of a simple support plate that is mounted to the chair by a ratchet and pawl type arrangement.

A chair according to the present invention may include multiple fishing rod receptacles 50, which may be joined to multiple different portions of the chair 100, and may include receptacles of multiple different types (e.g., a fixed position cylindrical receptacle joined to a first beam, and a rotatable clamp mechanism receptacle joined to a second beam).

A collapsible chair according to the present invention is not limited to the constructions shown in the figures, and may instead take any number of different constructions that do not deviate from the spirit of the present invention, as characterized by the appended claims. For example a chair 100 according to the present invention may include beams and panels made of any chosen material or combination of materials; may include any number of panels that are formed continuously or separately from one another, including for example a leg rest panel that extends between beams forming the front legs 21R/L.

The present invention is not limited to the exemplary embodiments illustrated herein, but is instead characterized by the appended claims.

What is claimed is:

1. A collapsible chair, comprising:
a frame structure comprising multiple beams and multiple panels, the multiple beams being configured to form a chair frame and the multiple panels being configured to form support surfaces extending between beams, the supporting surfaces including a seating surface and a backrest surface; and
a rod receptacle joined to a beam, the rod receptacle being configured to receive and retain a fishing rod.

2. The collapsible chair according to claim 1, wherein
the frame structure comprises beams configured to form armrests of the chair frame, with at least one armrest comprising a measuring device for measuring length.

3. The collapsible chair according to claim 2, wherein
at least one measuring device on at least one armrest is a length-measuring scale in the form of a scale ruler that extends along a length of the armrest for measuring the length of a fish.

4. The collapsible chair according to claim 3, wherein
the scale ruler is printed along the surface of the armrest.

5. The collapsible chair according to claim 3, wherein
the scale ruler is an engraved along the surface of the armrest.

6. The collapsible chair according to claim 1, wherein
the rod receptacle is formed as a cylindrical tube having an open end and a length dimensioned for insertion of a handle-end of a fishing rod.

7. The collapsible chair according to claim 6, wherein
the rod receptacle is mounted to the chair frame at an angle between 30° and 90°.

8. The collapsible chair according to claim 6, wherein
the rod receptacle is mounted to the chair frame at an angle between 45° and 75°.

9. The collapsible chair according to claim 6, wherein
the rod receptacle is mounted to the chair frame at an angle between 55° and 70°.

10. The collapsible chair according to claim 6, wherein
the rod receptacle is rotatably mounted to the chair frame.

11. The collapsible chair according to claim 1, wherein
the rod receptacle is formed as a clamp mechanism that is operable between an open state for insertion and removal of a fishing rod, and a close state for retention of a fishing rod.

12. The collapsible chair according to claim 11, wherein
the rod receptacle is mounted to the chair frame at an angle between 30° and 90°.

13. The collapsible chair according to claim 11, wherein
the rod receptacle is mounted to the chair frame at an angle between 45° and 75°.

14. The collapsible chair according to claim 11, wherein
the rod receptacle is mounted to the chair frame at an angle between 55° and 70°.

15. The collapsible chair according to claim 11, wherein
the rod receptacle is rotatably mounted to the chair frame.
